(19) United States
(12) Patent Application Publication
(10) Pub. No.: US 2007/0102041 A1
(43) Pub. Date: May 10, 2007

(54) Valve

(76) Inventor: Trevor Poulter, West Yorkshire (GB)

Correspondence Address: BARNES & THORNBURG LLP, P.O. BOX 2786, CHICAGO, IL, 60690-2786, US

(21) Appl. No.: 10/550,430

(22) PCT Filed: Mar. 23, 2004
(86) PCT No.: PCT/GB04/01283

§ 371 Date: Jan. 8, 2007

(30) Foreign Application Priority Data
Mar. 25, 2003 (GB) 0306767.5

(51) Int. Cl. F16K 17/40

(52) U.S. Cl. 137/68.29

(57) ABSTRACT

A valve for use in controlling the flow of liquid out of a container, the valve comprising a valve body (14) having an inlet (15) and an outlet (16) for liquid, a valve seat (17) and a valve member (18) movable onto the valve seat (17) to close the valve, the valve also having a secondary seal in the form of a barrier member (25) positioned to prevent any leakage of liquid from the valve outlet. Such a valve is particularly effective for use with a container such an ISO container, which is going to be transported over a long distance, for example by sea The secondary seal prevents any leakage over a long period of time, thus reducing problems associated with aggressive liquids, for example corrosive liquids.

The invention relates to valves, and particularly, though not exclusively, to valves for use in controlling the flow of fluid out of containers, for example tanker vehicles.

Various types of valve for use in controlling the flow of liquid out of containers are well known, and generally comprise some type of valve member movable into an out of engagement with a valve seat. However such valves can leak, particularly over a period of time, for example if a container full of liquid is going to be transported over a long distance, for example by sea. Such leakage is not only undesirable in terms of lost product, but can also be harmful, for example in the case of aggressive liquids, which may, for example be corrosive.

The invention provides a valve for use in controlling the flow of liquid out of a container, the valve comprising a valve body having an inlet and an outlet for liquid, a valve seat, and a valve member movable onto the valve seat to close the valve, the valve also comprising a secondary seal in the form of a barrier member positioned to prevent any leakage of liquid from the valve outlet.

The valve may have means to breach the barrier when it is desired to use the valve to dispense liquid.

The means to breach the barrier may be activated by movement of the valve member off the valve seat.

The barrier may comprise a membrane.

The membrane may have at least one line of weakness to facilitate breaching of the membrane.

The valve may have a breaching member, the valve being such that movement of the valve member off the valve seat forces the membrane into engagement with the breaching member.

The breaching member may comprise a sharp edge.

The breaching member may be arranged at an angle such that when the valve member moves off the valve seat, the membrane is initially brought into engagement with a first part of the breaching member, thus applying concentrated breaching pressure to the membrane.

Alternatively, the breaching member may be provided with one or more teeth.

The valve member may be mounted in the valve body such that the valve member performs translational movement between open and closed positions.

The invention includes a container for liquid, when fitted with a valve as defined above.

The container for liquid may comprise an ISO container.

By way of example, a specific embodiment of the invention will now be described, with reference to the accompanying drawings, in which:

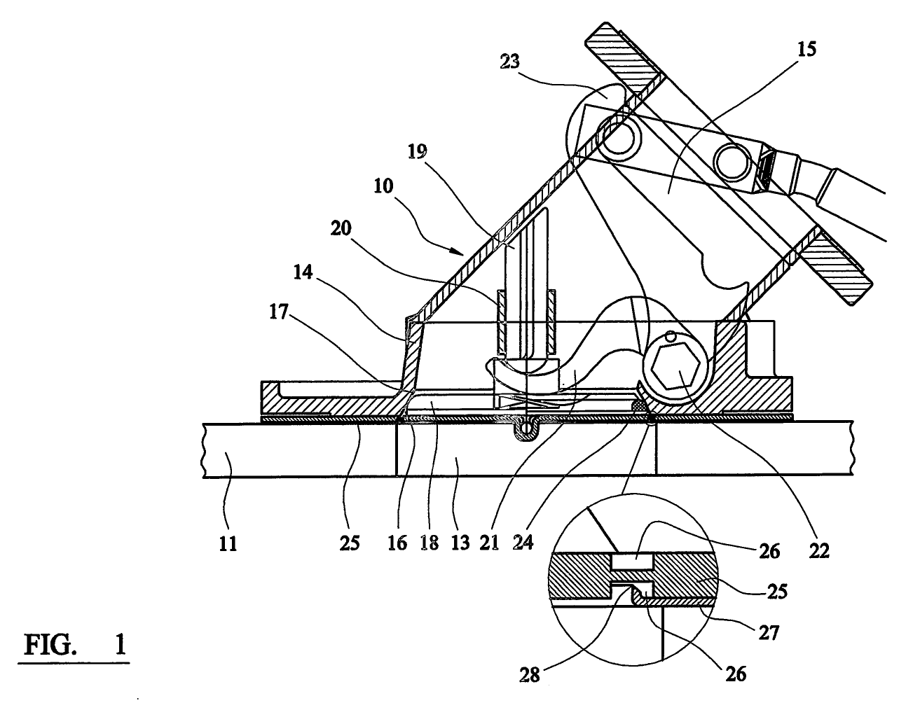

FIG. 1 is a cross-sectional view through one embodiment of valve according to the invention; and

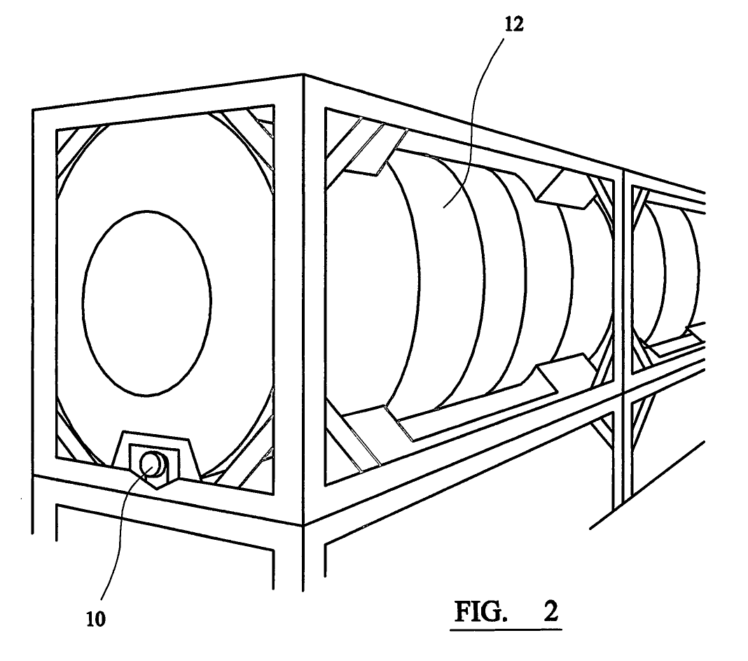

FIG. 2 is a view illustrating the embodiment of valve in situ on a container for liquid.

The embodiment of valve 10 shown in FIG. 1 is, in use, mounted on the inner face of the base 11 of a container 12 for liquid. The base 11 has an outlet aperture 13 therein.

The valve 10 comprises a valve body 14 having inlet 15 and an outlet 16. The outlet 16 is in registration with the aperture 13.

A tapered surface 17 of the valve body 14 comprises a valve seat. A valve member 18 is movable onto and off the valve seat to open and close the valve. The valve member 18 is guided for translational movement by means of a stem 19 sliding in a sleeve 20. The sleeve 20 is secured to the valve body 14.

Movement of the valve member 18 is carried out by a first pivotal lever 21 mounted on a shaft 22 extending through valve body 14. On the outside of the valve the shaft 22 is connected to another lever 23 which can be moved in any desired manner to operate the valve.

Although the valve member 18 is fitted with a ring seal 24, the valve member may leak over a significant period of time, for example if the container has to be transported over a long distance.

Accordingly, a secondary seal is provided in the form of a membrane 25 which is trapped between the valve body 14 and the base 11 of the container, in such a way that the membrane provides a total barrier across the outlet of the valve.

As seen in the enlarged portion of FIG. 1, the membrane 25 has a circular line of weakness provided by regions 26 of reduced thickness.

Also trapped between the valve body 14 and the base 11 is a breaching member 27 having an annular cutting edge 28.

When the valve member 18 is in position on the valve seat 17, the membrane 25 is spaced from the cutting edge 28 and provides a total seal preventing leakage of liquid from the container, even if some liquid seeps past the ring seal 24.

When a container reaches its destination and it is desired to dispense liquid, movement of the valve member 18 off the valve seat 17, by actuation of the external lever 23, forces the weakened portion of the membrane 25 against the knife edge 28, fracturing the membrane and permitting liquid to pass out of the container.

Other embodiments are possible. A valve may for example be arranged to move a breaching member into contact with a membrane, instead of moving a membrane into contact with a breaching member.

The breaching member may have a different configuration to the knife-edge shown in FIG. 1. For example, the breaching member may be provided with one or more cutting teeth.

The valve is particularly appropriate for use with an ISO container which might be transported over a long distance, for example by sea. FIG. 2 is a perspective view of an ISO container 12, the valve 10 being positioned at the point shown in the figure.

A particularly suitable material for the membrane is PTFE.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A valve for use in controlling the flow of liquid out of a container, the valve comprising a valve body having an inlet and an outlet for liquid, a valve seat, and a valve member movable onto the valve seat to close the valve, the valve also comprising a secondary seal in the form of a barrier member positioned to prevent any leakage of liquid from the valve outlet.

2. A valve as claimed in claim 1, having means to breach the barrier when it is desired to use the valve to dispense liquid.

3. A valve as claimed in claim 2, in which the means to breach the barrier is activated by movement of the valve member off the valve seat.

4. A valve as claimed in claim 1, in which the barrier comprises a membrane.

5. A valve as claimed in claim 4, in which the membrane has at least one line of weakness to facilitate breaching of the membrane.

6. A valve as claimed in claim 4, in which the valve has a breaching member, the valve being such that movement of the valve member off the valve seat forces the membrane into engagement with the breaching chamber.

7. A valve as claimed in claim 6, in which the breaching member comprises a sharp edge.

8. A valve as claimed in claim 6, in which the breaching member is arranged at an angle such that when the valve seat, the membrane is initially brought into engagement with a first part of the breaching member, thus applying concentrated breaching pressure to the membrane.

9. A valve as claimed in claim 6, in which the breaching member is provided with one or more teeth.

10. A valve as claimed in claim 4, in which the valve member is mounted in the valve body such that the valve member performs translational movement between open and closed positions.

11. A container as claimed in claim 4, in which the valve member is mounted in the valve body such that the valve member performs transitional movement between opened and closed positions.

12. A container as claimed in claim 11, comprising an ISO container.
